(19) United States
(12) Patent Application Publication
(10) Pub. No.: US 2019/0160860 A1
(43) Pub. Date: May 30, 2019

(54) PAINT CAN HOLSTER SYSTEM

(71) Applicants: Danny Clarke, Langley (CA); Derrick Blasco, Surrey (CA)

(72) Inventors: Danny Clarke, Langley (CA); Derrick Blasco, Surrey (CA)

(21) Appl. No.: 15/822,304

(22) Filed: Nov. 27, 2017

(51) Int. Cl. B44D 3/14; A45F 5/02

(52) U.S. Cl. CPC B44D 3/14; A45F 5/021

(57) ABSTRACT

A paint can holster system includes a holster assembly having a semi-arcuate support member having a first-end, and a second-end, a stabilizing brace having an aperture, a first-fastener, and a second-fastener. The aperture is able to receive a belt for securing the holster assembly at a hip of a user-wearer for providing ready access to contents of the paint can. The paint can when secured within the semi-arcuate support member is adjacent to a body of the user-wearer. The device provides a hands-free paint can hip holster.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of painting accessories and more specifically relates to a paint can holder.

### 2. DESCRIPTION OF RELATED ART

A paintbrush can only hold a fixed amount of paint at a time. It is therefore necessary, when painting with a paintbrush, to have a supply of paint accessible to the painter for replenishing the brush when required. This is often accomplished by placing a can of paint near the area being painted or holding a can of paint with one hand and painting with the brush in the other. It is often difficult to hold a paint can while painting. Additionally, the painter may be working for an extended period of time, it is also important and desirable that paint is readily accessible and allows the painter to comfortably replenish his paintbrush when necessary. A suitable solution is desired.

U.S. Pat. No. 4,527,720 to Arthur R. Hayes relates to a paint can holder or the like. The described paint can holder is adapted to be suspended from the belt of the user thereof and supports a container such as a paint bucket by the bail thereof. Due to an additional pivot in the device, the container will remain level and not spill the contents thereof as the user moves about.

### BRIEF SUMMARY OF THE INVENTION

In view of the foregoing disadvantages inherent in the known painting accessories art, the present disclosure provides a novel paint can holster system. The general purpose of the present disclosure, which will be described subsequently in greater detail, is to provide a hands-free paint can hip holster apparatus.

A paint can holster system is disclosed herein. The paint can holster system includes a holster assembly including a semi-arcuate support member having a first-end, and a second-end, a stabilizing brace having an aperture, a first-fastener, and a second-fastener. The holster assembly is defined by the semi-arcuate support member, the stabilizing brace, the first-fastener, and the second-fastener. The semi-arcuate support member is affixed to and extends from the stabilizing brace with an open-end opposing the stabilizing brace. The first-fastener is positioned at the first-end of the semi-arcuate support member. The second-fastener is positioned at the second-end of the semi-arcuate support member opposing the first-fastener. The first-fastener and the second fastener are configured to pivotally support a paint can. The first-fastener and the second fastener allow the paint can to swivel during an in use-condition. The aperture is configured to receive a belt for securing the holster assembly at a hip of a user-wearer for providing ready access to contents of the paint can.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a paint can holster system, constructed and operative according to the teachings of the present disclosure.

FIG. 1 is a perspective view of the paint can holster system during an ‘in-use’ condition, according to an embodiment of the disclosure.

FIG. 2 is a perspective view of the paint can holster system of FIG. 1, according to an embodiment of the present disclosure.

FIG. 3 is a perspective view of the paint can holster system of FIG. 1, according to an embodiment of the present disclosure.

FIG. 4 is a perspective view of the paint can holster system of FIG. 1, according to an embodiment of the present disclosure.

FIG. 5 is a perspective view of the paint can holster system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to paint accessories and more particularly to a paint can holster system as used to improve the use of paint cans and provides readily accessible paint for use.

Generally, the present invention is a device that maintains a paint can at hip height in a hands-free manner. This device includes both the half-moon attachment arm, stabilizing brace to secure against the wearers hip as well as the paint can for use at hip height or when both hands must not be occupied. The functional advantage is safety, convenience, and significantly reduced potential paint spillage. The paint can swivels at two hinges, keeping the can at 180 degrees to the ground regardless of the positioning of the wearer.

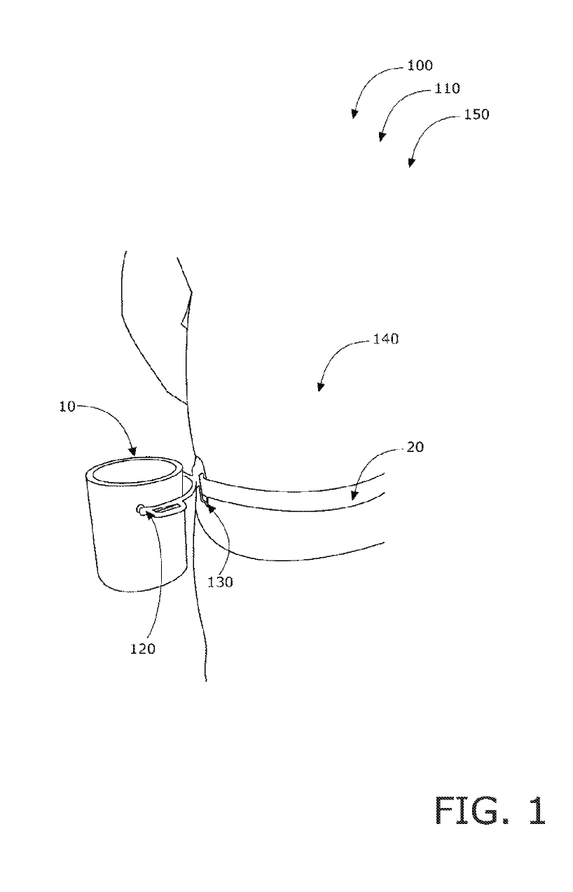

Referring now more specifically to the drawings by numerals of reference, there is shown in FIGS. 1-5, various views of a paint can holster system 100. FIG. 1 shows a paint can holster system 100 during an ‘in-use’ condition 150, according to an embodiment of the present disclosure. As illustrated, the paint can holster system 100 may include a holster assembly 110 including a semi-arcuate support member 120 having a first-end 122, and a second-end, a stabilizing brace 130 having an aperture 132, a first-fastener 136, and a second-fastener 138. The paint can holster system 100 provides a hands-free solution for carrying a paint can 10 for ready access to paint within the paint can.

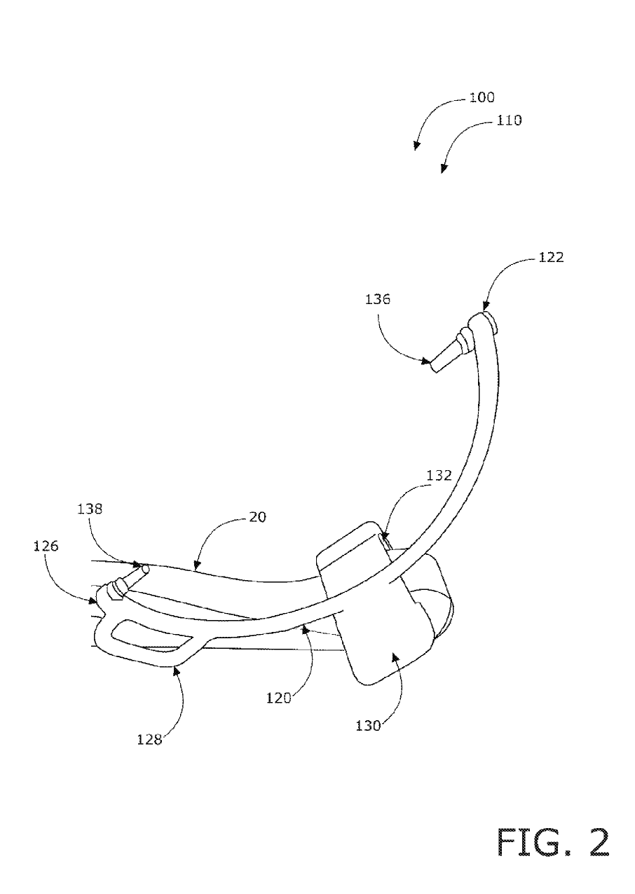

FIG. 2 shows a perspective view of the paint can holster system 100 of FIG. 1, according to an embodiment of the present disclosure. As above, the paint can holster system 100 may include the holster assembly 110 including the semi-arcuate support member 120 having the first-end 122, and the second-end 126, the stabilizing brace 130 having the aperture 132, the first-fastener 136, and the second-fastener 138. The holster assembly 110 is defined by the semi-arcuate support member 120, the stabilizing brace 130, the first-fastener 136, and the second-fastener 138. The semi-arcuate support member 120 is affixed to and extends from the stabilizing brace 130 with an open-end opposing the stabilizing brace 130.

The first-fastener 136 is positioned at the first-end 122 of the semi-arcuate support member 120. The second-fastener 138 is positioned at the second-end 126 of the semi-arcuate support member opposing the first-fastener 120. The first-fastener 136 and the second fastener 138 are configured to pivotally support a paint can 10. The first-fastener 136 and the second fastener 138 allow the paint can 10 to swivel during an in use-condition. The aperture 132 is configured to receive a belt 20 for securing the holster assembly 110 at a hip of a user-wearer for providing ready access to contents of the paint can 10. The paint can 10 when secured within the semi-arcuate support member 120 is adjacent to a body of the user-wearer 140.

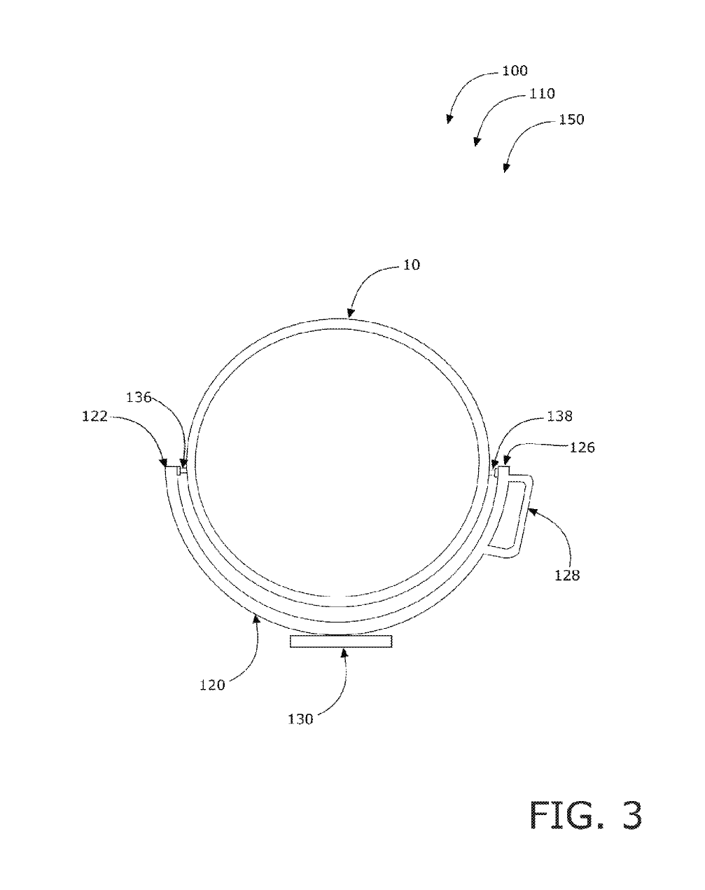

FIG. 3 shows a perspective view of the paint can holster system 100 of FIG. 1, according to an embodiment of the present disclosure. As above, the paint can holster system 100 may include the holster assembly 110 having the semi-arcuate support member 120 and the stabilizing brace 130 for supporting a paint can 10 at a hip of a user-wearer 140 when configured on a belt 20. The aperture 132 of the stabilizing brace 130 comprises a channel dimensioned to receive the belt 20 therein. The semi-arcuate support member 120 and the stabilizing brace 130 are rigid and are configured to support a weight of the paint can 10. The semi-arcuate support member 120 may further include a second-support-member 128. The semi-arcuate support member 120 and the stabilizing brace 130 comprise metal or other suitable rigid material. The semi-arcuate support member 120 contours to a profile of the paint can 10. The paint can 10 is supported in a substantially horizontal position. The paint can 10 is supported 180 degrees from a ground surface running parallel regardless of a relative standing/leaning position of the user-wearer 140 during normal movement.

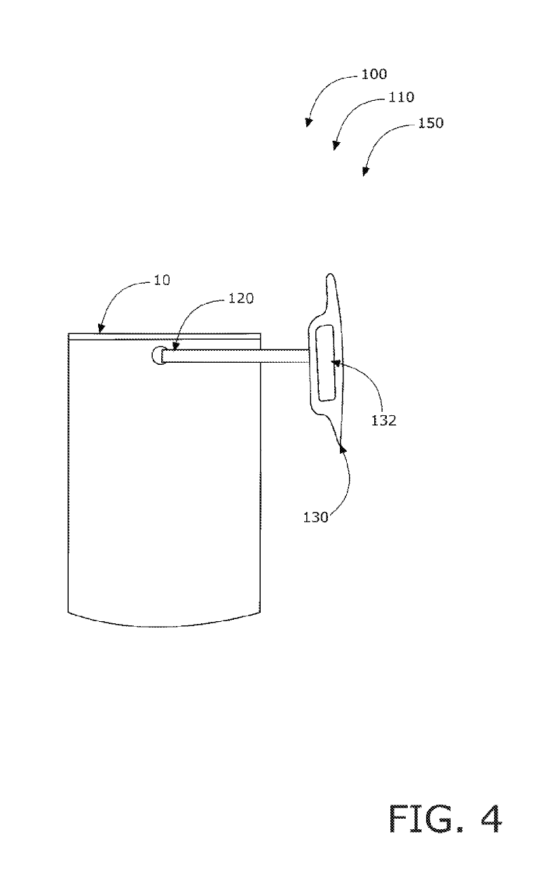

FIG. 4 shows a perspective view of the paint can holster system 100 of FIG. 1, according to an embodiment of the present disclosure. As above, the paint can holster system 100 may include the holster assembly 110 including the semi-arcuate support member 120 having the first-end 122, and the second-end 126, the stabilizing brace 130 having the aperture 132, the first-fastener 136, and the second-fastener 138. The first-end 122 of the semi-arcuate support member 120 attaches to a first-paint-can-handle-attachment-point (located where a paint can handle would normal connect to the paint can on opposing sides) via the first-fastener 136, and the second-end 126 of the semi-arcuate support member 120 attaches to a second-paint-can-handle-attachment-point via the second-fastener 138. The first-fastener 136 and the second-fastener 138 comprise hinge-members. The first-fastener 136 and the second-fastener 138 allow for slight swivel movement of the paint can 10.

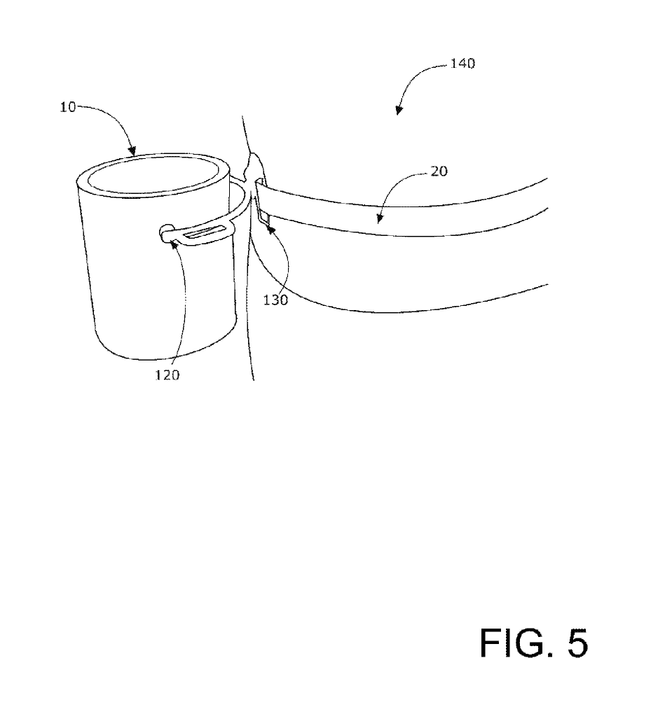

FIG. 5 shows a perspective view of the paint can holster system 100 of FIG. 1, according to an embodiment of the present disclosure. As above, the paint can holster system 100 may include the holster assembly 110 having the semi-arcuate support member 120 and the stabilizing brace 130. The stabilizing brace 130 comprises a planar back surface. The planar back surface is parallel to the body of the user-wearer 140 during an in-use condition. A top rim of the paint can 10 is parallel with the semi-arcuate support member 120 during an in-use condition. The top rim of the paint can 10 is positioned above the semi-arcuate support member 120 during an in-use condition. The paint can 10 when secured within the semi-arcuate support member 120 is proximal to the inner-circumference of the semi-arcuate support member 120 with a gap between the paint can 10 and the inner-circumference of the semi-arcuate support member 120.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A paint can holster system comprising:
a holster assembly including;
a semi-arcuate support member having;
a first-end; and
a second-end;
a stabilizing brace having;
an aperture;
a first-fastener; and
a second-fastener;
wherein said holster assembly is defined by said semi-arcuate support member, said stabilizing brace, said first-fastener, and said second-fastener;
wherein said semi-arcuate support member is affixed to and extends from said stabilizing brace with an open-end opposing said stabilizing brace;
wherein said first-fastener is positioned at said first-end of said semi-arcuate support member;
wherein said second-fastener is positioned at said second-end of said semi-arcuate support member opposing said first-fastener;
wherein said first-fastener and said second fastener are configured to pivotally support a paint can;
wherein said first-fastener and said second fastener allow said paint can to swivel during an in use-condition; and
wherein said aperture is configured to receive a belt for securing said holster assembly at a hip of a user-wearer for providing ready access to contents of said paint can.

2. The paint can holster system of claim 1, wherein said semi-arcuate support member is rigid and configured to support a weight of said paint can.

3. The paint can holster system of claim 2, wherein said paint can is supported in a substantially horizontal position.

4. The paint can holster system of claim 3, wherein said paint can is supported 180 degrees from a ground surface running parallel regardless of a relative standing position of said user-wearer during normal movement.

5. The paint can holster system of claim 1, wherein said first-end of said semi-arcuate support member attaches to a first-paint-can-handle-attachment-point via said first-fastener, and said second-end of said semi-arcuate support member attaches to a second-paint-can-handle-attachment-point via said second-fastener.

6. The paint can holster system of claim 5, wherein said first-fastener and said second-fastener comprise hinge-members.

7. The paint can holster system of claim 6, wherein said first-fastener and said second-fastener allow for slight swivel movement of said paint can.

8. The paint can holster system of claim 1, wherein said stabilizing brace is rigid.

9. The paint can holster system of claim 1, wherein said aperture comprises a channel dimensioned to receive said belt therein.

10. The paint can holster system of claim 1, wherein said semi-arcuate support member contours to a profile of said paint can.

11. The paint can holster system of claim 1, wherein said paint can when secured within said semi-arcuate support member is adjacent to a body of said user-wearer.

12. The paint can holster system of claim 10, wherein said semi-arcuate support member comprises a second-support-member.

13. The paint can holster system of claim 1, wherein said semi-arcuate support member and said stabilizing brace comprise metal.

14. The paint can holster system of claim 1, wherein said stabilizing brace comprises a planar back surface.

15. The paint can holster system of claim 14, wherein said planar back surface is parallel to said body of said user-wearer during an in-use condition.

16. The paint can holster system of claim 1, wherein a top rim of said paint can is parallel with said semi-arcuate support member during an in-use condition.

17. The paint can holster system of claim 16, wherein said top rim of said paint can is positioned above said semi-arcuate support member during an in-use condition.

18. The paint can holster system of claim 1, wherein said paint can when secured within said semi-arcuate support member is proximal to said inner-circumference of said semi-arcuate support member with a gap between said paint can and said inner-circumference of said semi-arcuate support member.

19. A paint can holster system, the paint can holster system comprising:
a holster assembly including;
a semi-arcuate support member having;
a first-end; and
a second-end;
a stabilizing brace having;
an aperture;
a first-fastener; and
a second-fastener;
wherein said holster assembly is defined by said semi-arcuate support member, said stabilizing brace, said first-fastener, and said second-fastener;
wherein said semi-arcuate support member is affixed to and extends from said stabilizing brace with an open-end opposing said stabilizing brace;
wherein said semi-arcuate support member and said stabilizing brace comprise metal;
wherein said semi-arcuate support member contours to a profile of said paint can;
wherein said semi-arcuate support member is rigid and configured to support a weight of said paint can;
wherein said stabilizing brace is rigid;
wherein said stabilizing brace comprises a planar back surface;
wherein said planar back surface is parallel to said body of a user-wearer during an in-use condition
wherein said first-fastener is positioned at said first-end of said semi-arcuate support member;
wherein said second-fastener is positioned at said second-end of said semi-arcuate support member opposing said first-fastener;
wherein said first-end of said semi-arcuate support member attaches to a first-paint-can-handle-attachment-point via said first-fastener, and said second-end of said semi-arcuate support member attaches to a second-paint-can-handle-attachment-point via said second-fastener;
wherein said first-fastener and said second-fastener comprise hinge-members;
wherein said first-fastener and said second fastener are configured to pivotally support a paint can;
wherein said first-fastener and said second fastener allow said paint can to swivel during an in use-condition;
wherein said first-fastener and said second-fastener allow for slight swivel movement of said paint can;
wherein said paint can is supported in a substantially horizontal position;
wherein said paint can is supported 180 degrees from a ground surface running parallel regardless of a relative standing position of said user-wearer during normal movement;
wherein said aperture is configured to receive a belt for securing said holster assembly at a hip of a user-wearer for providing ready access to contents of said paint can;
wherein said aperture comprises a channel dimensioned to receive said belt therein;
wherein said paint can when secured within said semi-arcuate support member is adjacent to a body of said user-wearer;
wherein said semi-arcuate support member comprises a second-support-member;
wherein a top rim of said paint can is parallel with said semi-arcuate support member during an in-use condition;
wherein said top rim of said paint can is positioned above said semi-arcuate support member during an in-use condition; and
wherein said paint can when secured within said semi-arcuate support member is proximal to said inner-circumference of said semi-arcuate support member with a gap between said paint can and said inner-circumference of said semi-arcuate support member.
